(19) United States
(12) Patent Application Publication
(10) Pub. No.: US 2026/0180637 A1
(43) Pub. Date: Jun. 25, 2026

(54) BEAMFORMING FOR INTERFERENCE SUPPRESSION IN WIRELESS NETWORKS

(71) Applicant: SAMSUNG ELECTRONICS CO., LTD., Suwon-si (KR)

(72) Inventors: Wan Choi, Seoul (KR); Jiyoung Yun, Seoul (KR); Hongjun Heo, Seoul (KR)

(73) Assignees: SAMSUNG ELECTRONICS CO., LTD., Suwon-si (KR); Seoul National University R&DB Foundation, Seoul (KR)

(21) Appl. No.: 19/425,101

(22) Filed: Dec. 18, 2025

(30) Foreign Application Priority Data
Dec. 19, 2024 (KR) 10-2024-0191707
May 20, 2025 (KR) 10-2025-0065729

(51) Int. Cl. H04B 7/06

(52) U.S. Cl. CPC H04B 7/0617

(57) ABSTRACT

An operating method of a wireless communication device may include calculating a plurality of azimuth angles between a plurality of communication target devices and the wireless communication device, respectively, calculating a plurality of communication distances between the plurality of communication target devices and the wireless communication device, respectively, sorting the plurality of communication target devices, based on the plurality of azimuth angles and the plurality of communication distances, respectively, determining a plurality of beamforming matrixes on the sorted plurality of communication target devices, respectively, and generating a wireless signal which is to be transmitted to the plurality of communication target devices, based on the plurality of beamforming matrixes, respectively.

### CROSS-REFERENCE TO RELATED APPLICATIONS

This application is based on and claims priority under 35 U.S.C. § 119 to Korean Patent Application Nos. 10-2024-0191707, filed on Dec. 19, 2024, and 10-2025-0065729, filed on May 20, 2025, in the Korean Intellectual Property Office, the disclosures of which are incorporated by reference herein in their entireties.

### BACKGROUND

The present disclosure relates to a wireless communication device which may perform interference removal to transmit a wireless signal.

In a wireless communication system, a base station may communicate with a plurality of user equipment. In this case, the base station may perform interference removal beamforming so that a signal to be transmitted to a specific user is not recognized as interference by another user.

The base station may transmit a wireless signal to a plurality of user equipment by using a plurality of antennas. As described above, because the plurality of antennas are used, overhead may increase due to an arithmetic operation for interference removal beamforming. Therefore, various methods which may minimize overhead caused by an arithmetic operation and may perform interference removal beamforming are being developed.

### SUMMARY

In one or more embodiments, there is provided an operating method of a wireless communication device performing communication with a plurality of communication target devices. The operating method may include: calculating a plurality of azimuth angles between the plurality of communication target devices and the wireless communication device, respectively; calculating a plurality of communication distances between the plurality of communication target devices and the wireless communication device, respectively; sorting the plurality of communication target devices, based on the plurality of azimuth angles and the plurality of communication distances, respectively; determining a plurality of beamforming matrixes on the sorted plurality of communication target devices, respectively; and generating a wireless signal which is to be transmitted to the plurality of communication target devices, based on the plurality of beamforming matrixes, respectively.

In one or more embodiments, there is provided a wireless communication device performing communication with a plurality of communication target devices. The wireless communication device may include: a processor configured to generate a wireless signal; and a transceiver configured to transmit the wireless signal. The processor may be configured to calculate a plurality of azimuth angles between the plurality of communication target devices and the wireless communication device, respectively, calculate a plurality of communication distances between the plurality of communication target devices and the wireless communication device, respectively, sort the plurality of communication target devices, based on the plurality of azimuth angles and the plurality of communication distances, respectively, determine a plurality of beamforming matrixes on the sorted plurality of communication target devices, respectively, and generate the wireless signal which is to be transmitted to the plurality of communication target devices, based on the plurality of beamforming matrixes.

In one or more embodiments, there is provided a method of performing interference removal beamforming in a wireless communication system including a base station and a plurality of user terminals. The method may include: identifying spatial relationships between the base station and the plurality of user terminals using azimuth parameters and distance parameters between the base station and the plurality of user terminals; sorting the plurality of user terminals based on the azimuth parameters to form an azimuth-ordered list; selecting, from the azimuth-ordered list, a subset of user terminals located within a predefined beam width of the base station; sorting the selected subset of user terminals based on the distance parameters to form a distance-ordered list; determining a plurality of beamforming matrixes based on the distance-ordered list of the plurality of user terminals, and generating a wireless signal which is to be transmitted to the plurality of user terminals, based on the plurality of beamforming matrixes.

### BRIEF DESCRIPTION OF DRAWINGS

Embodiments will be more clearly understood from the following detailed description taken in conjunction with the accompanying drawings in which:

FIG. 1 is a diagram illustrating a wireless communication system according to an embodiment;

FIG. 2 is a block diagram illustrating a wireless communication device according to an embodiment;

FIG. 3 is a diagram for describing an operation criterion of a communication distance and an azimuth between a wireless communication device and a communication target device, according to an embodiment;

FIG. 4 is a diagram illustrating an example of a relationship between a plurality of communication target devices and a wireless communication device, according to an embodiment;

FIG. 5 is a diagram illustrating an example where a wireless communication device according to an embodiment sorts a plurality of communication target devices, based on a plurality of azimuths and a plurality of communication distances;

FIG. 6 is a diagram illustrating an example where a wireless communication device according to an embodiment determines a beamforming matrix of each of sorted plurality of communication target devices;

FIG. 7 is a flowchart illustrating an operating method of a wireless communication device, according to an embodiment;

FIG. 8 is a flowchart illustrating an example of a detailed method which sorts a plurality of communication target devices in an operating method of a wireless communication device, according to an embodiment;

FIG. 9 is a flowchart illustrating an example of a detailed method which performs second sorting of a plurality of communication target devices in an operating method of a wireless communication device, according to an embodiment; and

FIG. 10 is a block diagram illustrating a wireless communication device according to an embodiment.

### DETAILED DESCRIPTION

Hereinafter, embodiments will be described in detail with reference to the accompanying drawings.

In the present disclosure, the term “an embodiment” is intended to encompass one or more embodiments, rather than being limited to a single example. Furthermore, features described in embodiments may be combined and implemented together.

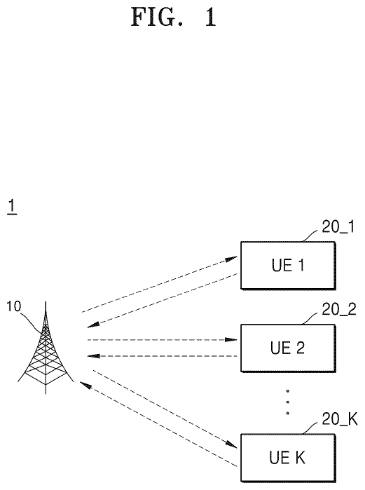

FIG. 1 is a diagram illustrating a wireless communication system 1 according to an embodiment.

Referring to FIG. 1, the wireless communication system 1 according to an embodiment may include a base station 10 and a plurality of user equipment (UE) 20_1, 20_2, . . . 20_K.

The wireless communication system 1 may provide a communication service to the plurality of UE 20_1 to 20_K, based on at least one of a plurality of wireless networks. For example, the wireless communication system 1 may provide a communication service thereto based on at least one of 3rd generation (3G) network, 4th generation (4G) network, wireless broadband (Wibro) network, global system for mobile communication (GSM) network, 5th generation (5G) network, and 6th generation (6G) network.

Various functions described below may be implemented or supported by artificial intelligence (AI) technology or one or more computer programs, and each of the computer programs may include computer-readable program code and may be executed by a computer-readable medium. The terms “application” and “program” may refer to one or more computer programs, a software component, an instruction set, a procedure, a function, an object, a class, an instance, related data, or some thereof suitable for implementation of suitable computer-readable program code. The term “computer-readable program code” may refer to any type of computer code including source code, object code, and execution code. The term “computer-readable medium” may refer to any type of medium that is accessible by a computer like read only memory (ROM), random access memory (RAM), a hard disk drive, a compact disk, a digital video disk (DVD), or a memory of another type. A “non-transitory” computer-readable medium may exclude wired, wireless, optical, or other communication links, which transmit transitory electrical or other signals. A non-transitory computer-readable medium may include a medium which may permanently store data and a medium which may store data and may overwrite later like a re-recordable optical disk or an erasable memory device.

In embodiments described below, a hardware access method will be described as an example. However, embodiments may include technology which uses both hardware and software, and thus, embodiments may not exclude a software-based access method.

The base station 10 may represent a fixed station configured to communicate with the plurality of UE 20_1 to 20_K and may exchange control information and data with the plurality of UE 20_1 to 20_K. For example, the base station 10 may be variously referred to as a Node B, an evolved-Node B (eNB), a Next generation Node B (gNB), a Sector, a Site, a base transceiver system (BTS), an access point (AP), a relay node, a remote radio head (RRH), a radio unit (RU), a small cell, a wireless device, and a device.

Although FIG. 1 illustrates an embodiment where a single base station 10 is included in the wireless communication system 1, but the embodiment is not limited thereto. Unlike the illustration of FIG. 1, the wireless communication system 1 may include two or more base stations 10.

The plurality of UE 20_1 to 20_K may be fixed or mobile, and may represent any type of device capable of communicating with the base station 10 to transmit or receive data and/or control information. For example, the plurality of UE 20_1 to 20_K may be referred to as a terminal, terminal equipment, a mobile station (MS), a mobile terminal (MT), a user terminal (UT), a subscribe station (SS), a wireless communication device, a wireless device, a handheld device, or a communication target device.

The base station 10 and the plurality of UE 20_1 to 20_K may communicate with each other by using a plurality of antennas. In this case, the plurality of antennas may be included in the base station 10 and the plurality of UE 20_1 to 20_K in the form of antenna array. For example, the antenna array may have a plate structure.

The base station 10 may transmit a wireless signal to the plurality of UE 20_1 to 20_K by using the plurality of antennas. Also, the plurality of UE 20_1 to 20_K may receive the wireless signal transmitted by the base station 10 by using the plurality of antennas.

In an embodiment, the base station 10 may sort the plurality of UE 20_1 to 20_K, based on a plurality of azimuths which are angles between the plurality of UE 20_1 to 20_K and the base station 10 and a plurality of communication distances which are distances between the plurality of UE 20_1 to 20_K and the base station 10, may determine a plurality of beamforming matrixes on the sorted plurality of UE 20_1 to 20_K, and may transmit a wireless signal to the plurality of UE 20_1 to 20_K based on the plurality of beamforming matrixes. The base station 10 may determine a beamforming matrix, based on the plurality of azimuths and the plurality of communication distances, and thus, may minimize overhead caused by an arithmetic operation and may reduce or remove interference.

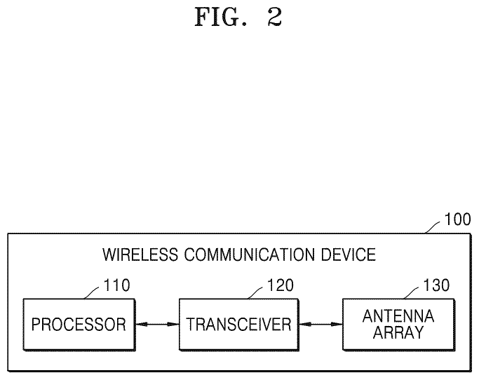

FIG. 2 is a block diagram illustrating a wireless communication device 100 according to an embodiment.

Referring to FIG. 2, the wireless communication device 100 according to an embodiment may include a processor 110, a transceiver 120, and an antenna array 130. The wireless communication device 100 according to an embodiment may be the base station 10 included in the wireless communication system 1 of FIG. 1, but the embodiment is not limited thereto.

The wireless communication device 100 may communicate with a plurality of communication target devices. The plurality of communication target devices may correspond to the plurality of UE 20_1 to 20_K included in the wireless communication system 1 of FIG. 1, but the embodiment is not limited thereto.

The processor 110 may control the overall operation of the wireless communication device 100, and may be configured with an architecture suitable for such control. In an embodiment, the processor 110 may include a communication processor. The processor 110 may generate a wireless signal for transmission to the plurality of communication target devices.

The transceiver 120 may transmit the wireless signal to the plurality of communication target devices through the antenna array 130. The transceiver 120 may modulate and amplify the wireless signal generated by the processor 110 to transmit to the plurality of communication target devices through the antenna array 130.

The antenna array 130 may include a plurality of antennas. The plurality of antennas included in the antenna array 130 may be arranged in a predetermined array. For example, the antenna array 130 may have a plate structure, and the plurality of antennas may be arranged on a two-dimensional (2D) plane.

In an embodiment, the processor 110 may sort the plurality of communication target devices, based on a plurality of azimuths and a plurality of communication distances, may determine a plurality of beamforming matrixes on the sorted plurality of communication target devices, and may transmit the wireless signal to the plurality of communication target devices based on the plurality of beamforming matrixes.

In more detail, the processor 110 may calculate the plurality of azimuths. The plurality of azimuths may be angles between the plurality of communication target devices and the wireless communication device 100. Each of the plurality of azimuths may be an angle between a reference line, which is referred to as a center intersection line, and each of a plurality of connection lines that extends from the center point of the antenna array 130 of the wireless communication device 100 to the center point of the antenna array of each communication target device. Specifically, here, each of the plurality of connection lines may be a line which connects a center of an antenna array of each of the plurality of communication target devices to a center intersection point of the antenna array 130 of the wireless communication device 100. The center intersection point may be an intersection point between the ground and a center of the antenna array 130 of the wireless communication device 100 when the antenna array 130 of the wireless communication device 100 moves in parallel in a vertical direction so that the center of the antenna array 130 of the wireless communication device 100 is disposed on the ground. The center intersection line may be an intersection line between the ground and the antenna array 130 of the wireless communication device 100 when the antenna array 130 of the wireless communication device 100 moves in parallel in a vertical direction so that the center of the antenna array 130 of the wireless communication device 100 is disposed on the ground.

Also, the processor 110 may calculate the plurality of communication distances. The plurality of communication distances may be distances between the plurality of communication target devices and the wireless communication device 100. Each of the plurality of communication distances may be a distance between the center of the antenna array of each of the plurality of communication target devices and the center of the antenna array 130 of the wireless communication device 100.

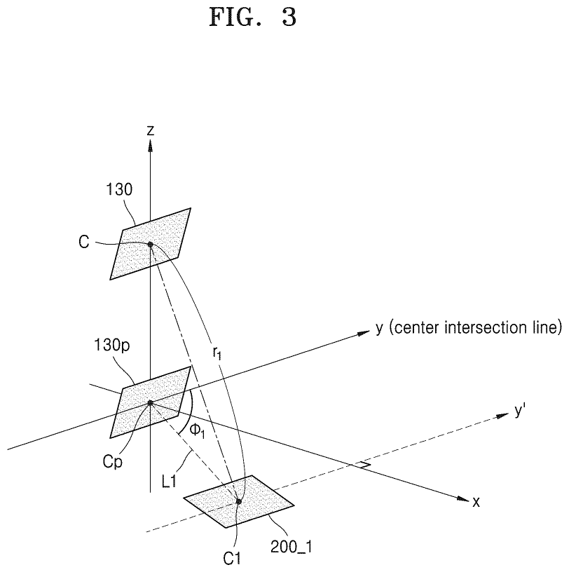

A criterion for calculating an azimuth and a communication distance may be described in more detail with reference to FIG. 3.

FIG. 3 is a diagram for describing an operation criterion of a communication distance and an azimuth between a wireless communication device and a communication target device, according to an embodiment.

Referring to FIG. 3, an example is illustrated in which a first antenna array 200_1 of a first communication target device, among a plurality of communication target devices, and the antenna array 130 of the wireless communication device 100 are shown on a coordinate axis.

A first azimuth φ₁ may be an angle between the wireless communication device 100 and the first communication target device. In this case, the first azimuth φ₁ may be an angle between the first connection line L1 and a center intersection line.

The first connection line L1 may be a line which connects a center C1 of the first antenna array 2001 of the first communication target device to a center intersection point Cp of the antenna array 130 of the wireless communication device 100. The center intersection point Cp may be an intersection point where a center C of the antenna array 130 of the wireless communication device 100 intersects the ground plane (i.e., the y-z plane in FIG. 3) when the antenna array 130 of the wireless communication device 100 is vertically projected onto the ground plane. That is, a center of a vertically-moved antenna array 130p (also referred to as ground-projected antenna array 130p) may be the center intersection point Cp (a starting point in the embodiment of FIG. 3).

The center intersection line may be an intersection line between the vertically-moved antenna array 130p and the ground, and may correspond to a y axis in the embodiment of FIG. 3.

To provide a summary description, in the embodiment of FIG. 3, the first azimuth φ₁ may be an angle between the first connection line L1 and the y axis, which is the center intersection line.

A first communication distance r₁ may be a distance between the wireless communication device 100 and the first communication target device. In this case, the first communication distance r₁ may be a distance between the center C1 of the first antenna array 200_1 and the center C of the antenna array 130 of the wireless communication device 100.

Referring again to FIG. 2, the processor 110 may calculate a plurality of azimuths and a plurality of communication distances with respect to the above description of FIG. 3. In this case, the processor 110 may calculate the plurality of azimuths and the plurality of communication distances by using methods commonly known.

The processor 110 may sort a plurality of communication target devices, based on the plurality of azimuths and the plurality of communication distances.

First, the processor 110 may perform first sorting on the plurality of communication target devices based on the plurality of azimuths to form an azimuth-ordered list. Hereinafter, the first sorting may refer to sorting based on the plurality of azimuths. In an embodiment, the processor 110 may perform the first sorting of the plurality of communication target devices in ascending order of the plurality of azimuths. In another embodiment, the processor 110 may perform the first sorting of the plurality of communication target devices in descending order of the plurality of azimuths.

Subsequently, the processor 110 may perform second sorting on the first-sorted plurality of communication target devices based on the plurality of communication distances to form a distance-ordered list. Hereinafter, the second sorting may refer to sorting based on the plurality of communication distances.

The processor 110 may select a communication target device, on which the second sorting is to be performed, from among the first-sorted plurality of communication target devices, based on a beam width of the wireless communication device 100. In other words, from among the first-sorted plurality of communication target devices, a subset of communication target devices is selected based on the beam width before the second sorting is applied. The beam width of the wireless communication device 100 may be a value which is determined based on the arrangement of a plurality of antennas included in the antenna array 130 of the wireless communication device 100. For example, the processor 110 may select a communication target device, on which the second sorting is to be performed, from among the plurality of communication target devices, based on the following Equation 1.

$$cos {ϕ}_{i + j} - cos {ϕ}_{i} \cdot < \frac{1}{{N}_{t}} \qquad [ Equation 1 ]$$

In Equation 1, φᵢ may denote an azimuth of a communication target device on which the first sorting has been performed in an ith order, φᵢ₊ⱼ may denote an azimuth of a communication target device on which the first sorting has been performed in an (i+j)th order, and Nₜ may denote the beam width of the wireless communication device 100. 1/Nₜ may represent an angular resolution (or directional selectivity) of the wireless communication device 100. When Equation 1 is satisfied, the processor 110 may select, as a communication target device on which the second sorting is to be performed, the communication target device on which the first sorting has been performed in the ith order or the communication target device on which the first sorting has been performed in the (i+j)th order. For example, when i=3 and j=2, the processor 110 may select, as communication target devices on which the second sorting is to be performed, a total of three communication target devices such as a communication target device on which the first sorting has been performed in a third order and a communication target device on which the first sorting has been performed in a fifth order. Equation 1 may be used to determine which communication target devices are close enough in direction (azimuth angle) to be reached by the same beam. If the difference in direction between two communication target devices, which are expressed using the cosine of their angles, is small enough, it indicates that the communication target devices are close together in direction. In that case, both communication target devices can be reached by the same beam and may be selected for further sorting. Conversely, Equation 1 may be used to filter out communication target devices that are too far apart in direction, as they cannot be reached by the same beam.

The processor 110 may second-sort a communication target device selected as a target for the second sorting, based on the plurality of communication distances. In an embodiment, the processor 110 may second-sort a communication target device selected as a target for the second sorting, in ascending of the plurality of communication distances. In another embodiment, the processor 110 may second-sort a communication target device selected as a target for the second sorting, in descending of the plurality of communication distances.

The embodiments of the present disclosure are not limited to performing the first sorting operation before the second sorting operation. In one or more embodiments, the order may be reversed such that the second sorting operation is performed before the first sorting operation, or the sorting may be performed by simultaneously considering both azimuth angles and communication distances.

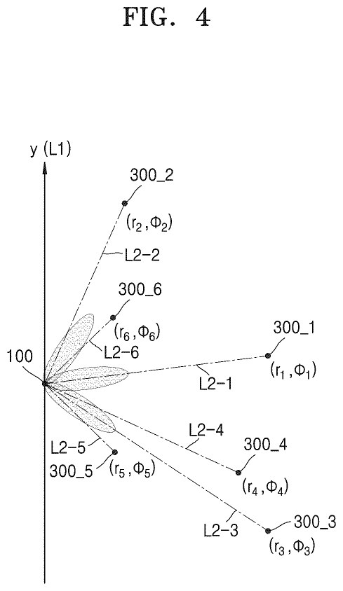

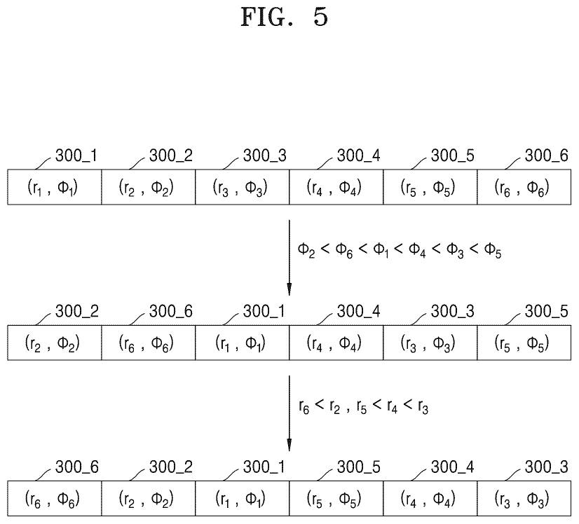

An embodiment where the processor 110 sorts a plurality of communication target devices, based on a plurality of azimuths and a plurality of communication distances, may be confirmed through FIGS. 4 and 5.

FIG. 4 is a diagram illustrating an example of a relationship between a plurality of communication target devices and a wireless communication device, according to an embodiment.

Referring to FIG. 4, the drawing briefly illustrates a relationship between a wireless communication device 100 and a plurality of communication target devices 300_1 to 300_6. When the wireless communication device 100 and the plurality of communication target devices 300_1 to 300_6 are seen downward from an upper end of a z axis in a coordinate axis as in FIG. 3, the drawing of FIG. 4 may be an embodiment of the relationship between the wireless communication device 100 and the plurality of communication target devices 300_1 to 300_6. In the embodiment of FIG. 4, an embodiment where six communication target devices (for example, first to sixth communication target devices) 300_1 to 300_6 are included in the wireless communication system 1 is illustrated, but the embodiment is not limited thereto.

The plurality of communication target devices 300_1 to 300_6 may be expressed with respect to a communication distance and an azimuth. For example, the first communication target device 300_1 may be expressed by a first communication distance r₁ which is a distance between the first communication target device 300_1 and the wireless communication device 100 and a first azimuth (01 which is an angle between the first communication target device 300_1 and the wireless communication device 100, and for example, may be expressed as (r₁, φ₁). Likewise, the second communication target device 300_2 may be expressed as (r₂, φ₂), the third communication target device 300_3 may be expressed as (r₃, φ₃), the fourth communication target device 3004 may be expressed as (r₄, φ₄), the fifth communication target device 3005 may be expressed as (r₅, φ₅), and the sixth communication target device 300_6 may be expressed as (r₆, φ₆).

FIG. 5 is a diagram illustrating an example where a wireless communication device according to an embodiment sorts a plurality of communication target devices, based on a plurality of azimuths and a plurality of communication distances.

Referring to FIG. 5, when a relationship between a wireless communication device 100 and a plurality of communication target devices (for example, first to sixth communication target devices) 300_1 to 300_6 is as illustrated in FIG. 4, an embodiment may be seen where the processor 100 sorts the plurality of communication target devices 300_1 to 300_6, based on a plurality of azimuths φ₁˜φ₆ and a plurality of communication distances (for example, first to sixth communication distances) r₁ to r₆.

An upper table of FIG. 5 may show a state where the plurality of communication target devices 300_1 to 300_6 are not yet sorted. In this state, the processor 110 may first-sort the plurality of communication target devices 300_1 to 300_6 based on the plurality of azimuths φ₁˜φ₆.

In the embodiment of FIG. 4, each of a plurality of azimuths φ₁˜φ₆ may be an angle between a y axis (i.e., a first connection line L1) and center intersection lines L2-1, L2-2, L2-3, L2-4, L2-5, and L2-6 that connects the wireless communication device 100 to each of the plurality of communication target devices 300_1 to 300_6, respectively. In the embodiment of FIG. 4, an order relation of the plurality of azimuths φ₁˜φ₆ may be expressed as the following Equation 2.

$${ϕ}_{2} < {ϕ}_{6} < {ϕ}_{1} < {ϕ}_{4} < {ϕ}_{3} < {ϕ}_{5} \qquad [ Equation 2 ]$$

The processor 110 may first-sort the plurality of communication target devices 300_1 to 300_6 based on Equation 2. The processor 110 may sort the plurality of communication target devices 300_1 to 300_6 in ascending order of the plurality of azimuths φ₁˜φ₆, and a result of the first sorting may be as shown in a middle table of FIG. 5. That is, the processor 110 may first-sort the plurality of communication target devices 300_1 to 300_6 in the order of the second communication target device 300_2, the sixth communication target device 300_6, the first communication target device 300_1, the fourth communication target device 300_4, the third communication target device 300_3, and the fifth communication target device 300_5.

Subsequently, the processor 110 may second-sort the first-sorted plurality of communication target devices 300_1 to 300_6 based on the plurality of communication distances r₁ to r₆. In more detail, the processor 110 may select a communication target device, on which the second sorting is to be performed, from among the first-sorted plurality of communication target devices 300_1 to 300_6, based on a beam width of the wireless communication device 100. For example, the processor 110 may select a communication target device on which the second sorting is to be performed, based on Equation 1.

In the embodiment of FIG. 4, the processor 110 may select, as communication target devices on which the second sorting is to be performed, the second communication target device 300_2 which is first-sorted in a first order and the sixth communication target device 300_6 which is first-sorted in a second order. For example, this selection may be based on Equation 1, which determines whether the azimuth angles of the two devices are sufficiently close, that is, within the beam width of the wireless communication device 100, to allow them to be reached by the same beam.

Also, in the embodiment of FIG. 4, the processor 110 may select, as communication target devices on which the second sorting is to be performed, the fourth communication target device 300_4 which is first-sorted in a fourth order, the third communication target device 300_3 which is first-sorted in a fifth order, and the fifth communication target device 300_5 which is first-sorted in a sixth order. This selection may satisfy Equation 1, indicating that the azimuth angle differences between the communication target devices 300_3, 300_4 and 300_5 fall within the allowable beam width. Accordingly, the processor 110 may select the fourth communication target device 300_4, the third communication target device 300_3, and the fifth communication target device 300_5 as communication target devices on which the second sorting is to be performed, as their respective azimuth angles are close enough to be covered by the same communication beam based on the beam width constraint expressed in Equation 1.

In the embodiment of FIG. 5, the second communication distance r₂ may be greater than the sixth communication distance r₆. Also, the third communication distance r₃ may be greater than the fourth communication distance r₄, and the fourth communication distance r₄ may be greater than the fifth communication distance r₅, and this may be expressed as the following Equation 3.

$${r}_{6} < {r}_{2} , {r}_{5} < {r}_{4} < {r}_{3} \qquad [ Equation 3 ]$$

The processor 110 may second-sort the plurality of communication target devices 300_1 to 300_6 based on Equation 3. The processor 110 may sort the plurality of communication target devices 300_1 to 300_6 in ascending order of the plurality of communication distances r₁ to r₆ between selected communication target devices, and a result of the second sorting may be as shown in a lower table of FIG. 5. That is, the processor 110 may second-sort the plurality of communication target devices 300_1 to 300_6 in the order of the sixth communication target device 300_6, the second communication target device 300_2, the first communication target device 300_1, the fifth communication target device 300_5, the fourth communication target device 300_4, and the third communication target device 300_3.

Referring again to FIG. 3, the processor 110 may determine a plurality of beamforming matrixes on an sorted plurality of communication target devices. The processor 110 may determine each of the plurality of beamforming matrixes so that interference between each of the sorted plurality of communication target devices and an adjacent communication target device is reduced or removed. The processor 110 may determine a plurality of beamforming matrixes on a plurality of communication target devices by using the following Equation 4.

$${M}_{k} = {F}_{k} - {F}_{k - 1} {F}_{k - 1}^{*} - {F}_{k + 1} {F}_{k + 1}^{*} \qquad [ Equation 4 ]$$

In Equation 4, Mₖ may denote a beamforming matrix of a communication target device sorted in a kth order, Fₖ may denote a phase change discrete Fourier transform (DFT) matrix of the communication target device sorted in the kth order, Fₖ₋₁ may denote a phase change DFT matrix of a communication target device sorted in a (k−1)th order, Fₖ₋₁* may denote a conjugate transposed matrix of the phase change DFT matrix of the communication target device sorted in the (k−1)th order, Fₖ₊₁ may denote a phase change DFT matrix of a communication target device sorted in a (k+1)th order, and Fₖ₊₁* may denote a conjugate transposed matrix of the phase change DFT matrix of the communication target device sorted in the (k+1)th order. As described above, the processor 110 may subtract, from a phase change DFT matrix of each of a plurality of communication target devices, a multiplication of a phase change DFT matrix of a communication target device and a conjugate transposed matrix of the phase change DFT matrix of the communication target device to determine a plurality of beamforming matrixes.

In this case, the phase change DFT matrix may be calculated as in the following Equation 5.

$${F}_{k} = {D}_{t , k} {Ω}_{{N}_{t}} \qquad [ Equation 5 ]$$

In Equation 5, D_{t,k} may denote a diagonal matrix where a phase change term based on an antenna of the wireless communication device 100 which is a transmission antenna is a diagonal component, and Ω_{N}_{ₜ} may denote a 2D DFT matrix.

In this case, D_{t,k} may be calculated by using the following Equation 6.

$${H}_{k}^{*} {H}_{k} = {D}_{t , k} {Ω}_{{N}_{t}} ( \begin{matrix}{I}_{{N}_{r}} & 0 \\ 0 & 0\end{matrix} ) {Ω}_{{N}_{t}}^{*} {D}_{t , k}^{*} \qquad [ Equation 6 ]$$

In Equation 6, Hₖ may denote a channel between a wireless communication device and a kth communication target device, and I_{N}_{ᵣ} may be an identity matrix.

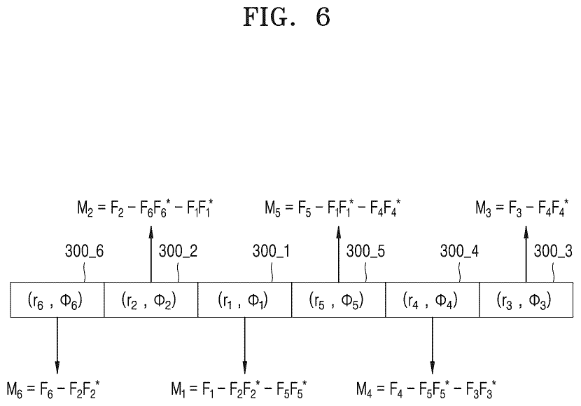

An embodiment where the processor 110 determines a plurality of beamforming matrixes on a plurality of communication target devices may be confirmed through FIG. 6.

FIG. 6 is a diagram illustrating an example where a wireless communication device according to an embodiment determines a beamforming matrix of each of an sorted plurality of communication target devices.

Referring to FIG. 6, a calculation method of a beamforming matrix of each of a second-sorted plurality of communication target devices (for example, first to sixth communication target devices) 300_1 to 300_6 may be confirmed as in FIG. 5.

First, a communication target device adjacent to the sixth communication target device 300_6 may be the second communication target device 300_2, and thus, M₆ which is a beamforming matrix of the sixth communication target device 300_6 may be determined by subtracting F₂F₂*, which is a multiplication of F₂ which is a phase change DFT matrix of the second communication target device 300_2 and F₂* which is a conjugate transposed matrix of the phase change DFT matrix of the second communication target device 300_2, from F₆ which is a phase change DFT matrix of the sixth communication target device 300_6.

Communication target devices adjacent to the second communication target device 300_2 may be the sixth communication target device 300_6 and the first communication target device 300_1, and thus, M₂ which is a beamforming matrix of the second communication target device 300_2 may be determined by subtracting, from F₂ which is a phase change DFT matrix of the second communication target device 300_2, F₆F₆* which is a multiplication of F₆ which is a phase change DFT matrix of the sixth communication target device 300_6 and F₆* which is a conjugate transposed matrix of the phase change DFT matrix of the sixth communication target device 300_6 and F₁F₁* which is a multiplication of F₁ which is a phase change DFT matrix of the first communication target device 300_1 and F₁* which is a conjugate transposed matrix of the phase change DFT matrix of the first communication target device 300_1.

Communication target devices adjacent to the first communication target device 300_1 may be the second communication target device 300_2 and the fifth communication target device 3005, and thus, M₁ which is a beamforming matrix of the first communication target device 300_1 may be determined by subtracting, from F₁ which is a phase change DFT matrix of the first communication target device 300_1, F₂F₂* which is a multiplication of F₂ which is a phase change DFT matrix of the second communication target device 300_2 and F₂* which is a conjugate transposed matrix of the phase change DFT matrix of the second communication target device 300_2 and F₅F₅* which is a multiplication of F₅ which is a phase change DFT matrix of the fifth communication target device 300_5 and F₅* which is a conjugate transposed matrix of the phase change DFT matrix of the fifth communication target device 3005.

Communication target devices adjacent to the fifth communication target device 300_5 may be the first communication target device 300_1 and the fourth communication target device 300_4, and thus, M₅ which is a beamforming matrix of the fifth communication target device 3005 may be determined by subtracting, from F₅ which is a phase change DFT matrix of the fifth communication target device 3005, F₁F₁* which is a multiplication of F₁ which is a phase change DFT matrix of the first communication target device 300_1 and F₁* which is a conjugate transposed matrix of the phase change DFT matrix of the first communication target device 300_1 and F₄F₄* which is a multiplication of F₄ which is a phase change DFT matrix of the fourth communication target device 300_4 and F₄* which is a conjugate transposed matrix of the phase change DFT matrix of the fourth communication target device 300_4.

Communication target devices adjacent to the fourth communication target device 300_4 may be the fifth communication target device 300_5 and the third communication target device 300_3, and thus, M₄ which is a beamforming matrix of the fourth communication target device 300_4 may be determined by subtracting, from F₄ which is a phase change DFT matrix of the fourth communication target device 300_4, F₅F₅* which is a multiplication of F₅ which is a phase change DFT matrix of the fifth communication target device 300_5 and F₅* which is a conjugate transposed matrix of the phase change DFT matrix of the fifth communication target device 300_5 and F₃F₃* which is a multiplication of F₃ which is a phase change DFT matrix of the third communication target device 300_3 and F₃* which is a conjugate transposed matrix of the phase change DFT matrix of the third communication target device 300_3.

Finally, a communication target device adjacent to the third communication target device 300_3 may be the fourth communication target device 300_4, and thus, M₃ which is a beamforming matrix of the third communication target device 300_3 may be determined by subtracting F₄F₄*, which is a multiplication of F₄ which is a phase change DFT matrix of the fourth communication target device 300_4 and F₄* which is a conjugate transposed matrix of the phase change DFT matrix of the fourth communication target device 300_4, from F₃ which is a phase change DFT matrix of the third communication target device 300_3.

Referring again to FIG. 3, the processor 110 may generate which is to be transmitted to a plurality of communication target devices, based on a plurality of beamforming matrixes. The processor 110 may multiply each of a plurality of transmission-targeted signals, which are to be transmitted to a plurality of communication target devices, by each of a plurality of beamforming matrixes to generate a wireless signal. For example, the processor 110 may multiply a first transmission-targeted signal, which is to be transmitted to a first communication target device, by a first beamforming matrix to generate a wireless signal.

As described above, the wireless communication device 100 according to an embodiment may determine a plurality of beamforming matrixes, based on a plurality of azimuths and a plurality of communication distances, and may transmit a wireless signal to a plurality of communication target devices based on the plurality of beamforming matrixes. As described above, a beamforming matrix may be determined based on a plurality of azimuths and a plurality of communication distances, and thus, may minimize overhead caused by an arithmetic operation and may reduce or remove interference.

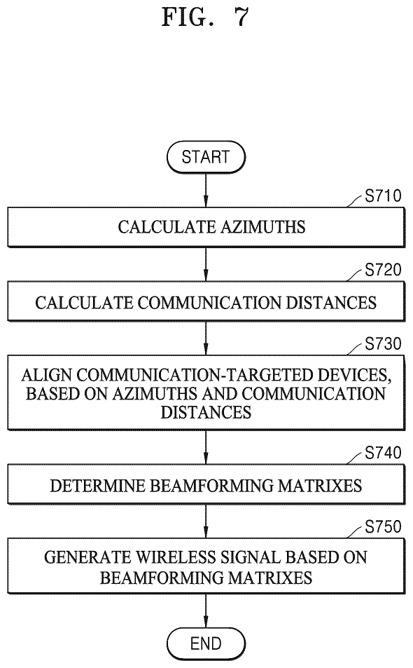

FIG. 7 is a flowchart illustrating an operating method of a wireless communication device, according to an embodiment.

Referring to FIG. 7, in operation S710, the wireless communication device 100 may calculate a plurality of azimuths. The wireless communication device 100 may calculate, as the plurality of azimuths, angles between a plurality of connection lines and a center intersection line.

In operation S720, the wireless communication device 100 may calculate a plurality of communication distances. The wireless communication device 100 may calculate, as the plurality of communication distances, distances between centers of antenna arrays of a plurality of communication target devices and a center of the antenna array 130 of the wireless communication device 100.

FIG. 7 illustrates an embodiment where the plurality of azimuths are calculated in operation S710, and then, the plurality of communication distances are calculated in operation S720, but the embodiment is not limited thereto. In some embodiments, operation S720 may be performed before or simultaneously with operation S710.

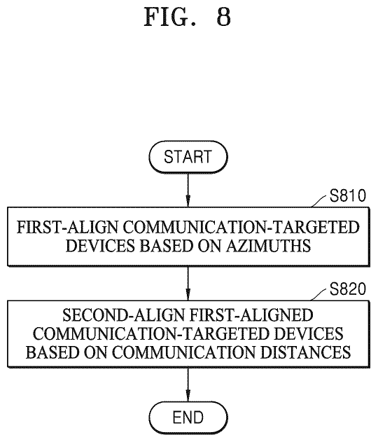

In operation S730, the wireless communication device 100 may sort the plurality of communication target devices, based on the plurality of azimuths and the plurality of communication distances. This may be described in more detail with reference to FIG. 8.

FIG. 8 is a flowchart illustrating an example of a detailed method which sorts a plurality of communication target devices in an operating method of a wireless communication device, according to an embodiment.

Referring to FIG. 8, in operation S810, the wireless communication device 100 may first-sort a plurality of communication target devices based on a plurality of azimuths. In an embodiment, the wireless communication device 100 may first-sort the plurality of communication target devices in ascending order of the plurality of azimuths. In another embodiment, the wireless communication device 100 may first-sort the plurality of communication target devices in descending order of the plurality of azimuths.

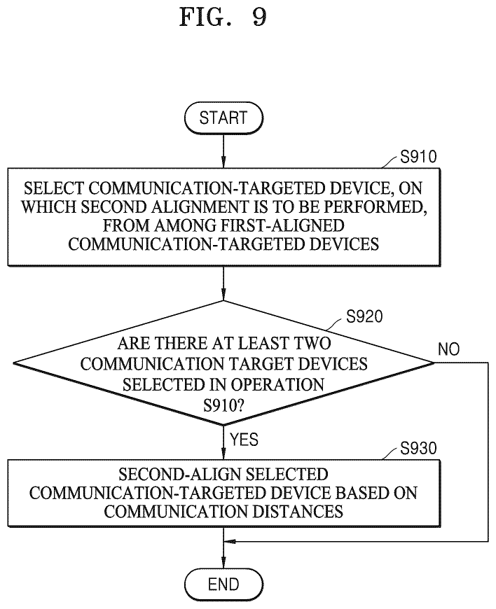

In operation S820, the wireless communication device 100 may second-sort the plurality of communication target devices based on a plurality of communication distances. This may be described in more detail with reference to FIG. 9.

FIG. 9 is a flowchart illustrating an example of a detailed method which performs second sorting of a plurality of communication target devices in an operating method of a wireless communication device, according to an embodiment.

Referring to FIG. 9, in operation S910, the wireless communication device 100 may perform an operation to select a subset of communication target devices that are eligible for second sorting, from among a first-sorted plurality of communication target devices. This selection may be based on a beam width of the wireless communication device 100, for example, using Equation 1 to determine whether the azimuthal separation between communication target devices fall within an acceptable range. This selection process may identify communication target devices that are directionally close enough to be reached by the same beam and are therefore valid candidates for second sorting

In operation S920, the wireless communication device 100 may determine whether the selection in operation S910 has resulted in at least two communication target devices. If fewer than two communication target devices are selected, the second sorting may not be performed, and the method shown in FIG. 9 may end.

When at least two communication target devices are selected, the wireless communication device 100 may perform second sorting on the selected subset of the communication target devices based on a plurality of communication distances. The second sorting may be performed in order of distances. In an embodiment, the second sorting may be performed in ascending order of the plurality of communication distances. In another embodiment, the second sorting may be performed in descending order of the plurality of communication distances. For example, the wireless communication device 100 may identify, a communication target device having a greatest interference influence on other communication target devices, and may generate the plurality of beamforming matrixes configured to reduce or remove interference caused by the communication target device.

Referring again to FIG. 7, in operation S740, the wireless communication device 100 may determine a plurality of beamforming matrixes. The wireless communication device 100 may determine each of the plurality of beamforming matrixes so that interference between each of the sorted plurality of communication target devices and an adjacent communication target device is reduced or removed.

In operation S750, the wireless communication device 100 may generate a wireless signal based on the plurality of beamforming matrixes. The wireless communication device 100 may multiply each of a plurality of transmission-targeted signals, which are to be transmitted to a plurality of communication target devices, by each of a plurality of beamforming matrixes to generate a wireless signal.

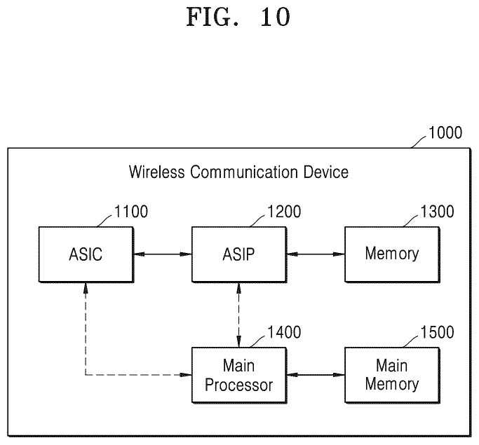

FIG. 10 is a block diagram illustrating a wireless communication device 1000 according to an embodiment.

Referring to FIG. 10, the wireless communication device 1000 may include an application specific integrated circuit (ASIC) 1100, an application specific instruction set processor (ASIP) 1200, a memory 1300, a main processor 1400, and a main memory 1500. Two or more of the ASIC 1100, the ASIP 1200, and the main processor 1400 may communicate with each other. Also, two or more of the ASIC 1100, the ASIP 1200, the memory 1300, the main processor 1400, and the main memory 1500 may be embedded in one chip.

The ASIC 1100 may be an integrated circuit which is customized for a specific use, and for example, may include a radio frequency integrated circuit (RFIC), a modulator, and a demodulator. The ASIP 1200 may support a dedicated instruction set for a specific application and may execute instructions included in the instruction set. The memory 1300 may communicate with the ASIP 1200 and may be a non-transitory storage device, and moreover, may store a plurality of instructions executed by the ASIP 1200. For example, the memory 1300 may include a memory of an arbitrary type accessible by the ASIP 1200 like ROM, RAM, tape, a magnetic disk, an optical disk, a volatile memory, a non-volatile memory, and a combination thereof.

The main processor 1400 may execute a plurality of instructions, and thus, may control the wireless communication device 1000. For example, the main processor 1400 may control the ASIC 1100 and the ASIP 1200, and moreover, may process data received through a wireless communication network or may process an input of a user on the wireless communication device 1000. The main memory 1500 may communicate with the main processor 1400 and may be a non-transitory storage device, and moreover, may store a plurality of instructions executed by the main processor 1400. For example, the main memory 1500 may correspond to any type of memory accessible by the main processor 1400 like ROM, RAM, tape, a magnetic disk, an optical disk, a volatile memory, a non-volatile memory, and a combination thereof.

The elements of the wireless communication device 100 according to an embodiment described above with reference to FIGS. 1 to 9 may correspond to or be included in at least one of the elements included in the wireless communication device 1000 of FIG. 10. For example, the processor 110 of the wireless communication device 100 of FIG. 2 may correspond to the ASIP 1200 of the wireless communication device 1000 of FIG. 10. The ASIP 1200 of FIG. 10 may determine a plurality of beamforming matrixes, based on a plurality of azimuths and a plurality of communication distances, and may transmit a wireless signal to a plurality of communication target devices based on the plurality of beamforming matrixes. As described above, a beamforming matrix may be determined based on a plurality of azimuths and a plurality of communication distances, and thus, may minimize overhead caused by an arithmetic operation and may reduce or remove interference.

In one or more embodiments, there is provided an operating method of a wireless communication device performing communication with a plurality of communication target devices. The operating method may include: calculating a plurality of azimuth angles between the plurality of communication target devices and the wireless communication device, respectively; calculating a plurality of communication distances between the plurality of communication target devices and the wireless communication device, respectively; sorting the plurality of communication target devices, based on the plurality of azimuth angles and the plurality of communication distances, respectively; determining a plurality of beamforming matrixes on the sorted plurality of communication target devices, respectively; and generating a wireless signal which is to be transmitted to the plurality of communication target devices, based on the plurality of beamforming matrixes, respectively.

The plurality of azimuth angles may be angles between a center intersection line and a plurality of connection lines, respectively. The plurality of connection lines connect centers of antenna arrays of the plurality of communication target devices to a center intersection point of the antenna array of the wireless communication device, respectively. The center intersection point may be an intersection point between a ground and a center of the antenna array of the wireless communication device when the center of the antenna array of the wireless communication device is vertically projected onto the ground. The center intersection line may be an intersection line between the ground and the antenna array of the wireless communication device when the center of the antenna array of the wireless communication device may be vertically projected onto the ground.

The plurality of communication distances may be distances between centers of antenna arrays of the plurality of communication target devices and a center of an antenna array of the wireless communication device, respectively.

The sorting may include: performing first sorting on the plurality of communication target devices based on the plurality of azimuth angles to obtain first-sorted plurality of communication target devices; and performing second sorting on the first-sorted plurality of communication target devices based on the plurality of communication distances.

The first sorting may include performing the first sorting on the plurality of communication target devices in ascending or descending order of the plurality of azimuth angles.

The second sorting may include: selecting a set of communication target devices, based on a beam width of the wireless communication device; and performing the second sorting on the selected set of communication target devices in ascending or descending order of the plurality of communication distances, based on the plurality of communication distances.

The determining the plurality of beamforming matrixes on the sorted plurality of communication target devices may include determining the plurality of beamforming matrixes so that interferences between the sorted plurality of communication target devices and an adjacent communication target device are reduced or removed.

The determining the plurality of beamforming matrixes may include subtracting, from phase change discrete Fourier transform (DFT) matrixes of the plurality of communication target devices, a multiplication of a phase change DFT matrix of the adjacent communication target device and a conjugate transposed matrix of the phase change DFT matrix of the adjacent communication target device to determine the plurality of beamforming matrixes, respectively.

The generating the wireless signal which is to be transmitted to the plurality of communication target devices may include multiplying a plurality of transmission-targeted signals, which are to be transmitted to the plurality of communication target devices, by the plurality of beamforming matrixes to generate the wireless signal.

In one or more embodiments, there is provided a wireless communication device performing communication with a plurality of communication target devices. The wireless communication device may include: a processor configured to generate a wireless signal; and a transceiver configured to transmit the wireless signal. The processor may be configured to calculate a plurality of azimuth angles between the plurality of communication target devices and the wireless communication device, respectively, calculate a plurality of communication distances between the plurality of communication target devices and the wireless communication device, respectively, sort the plurality of communication target devices, based on the plurality of azimuth angles and the plurality of communication distances, respectively, determine a plurality of beamforming matrixes on the sorted plurality of communication target devices, respectively, and generate the wireless signal which is to be transmitted to the plurality of communication target devices, based on the plurality of beamforming matrixes.

The plurality of azimuth may be angles between a center intersection line and a plurality of connection lines, respectively, the plurality of connection lines connect centers of antenna arrays of the plurality of communication target devices to a center intersection point of the antenna array of the wireless communication device, respectively, the center intersection point may be an intersection point between a ground and a center of the antenna array of the wireless communication device when the center of the antenna array of the wireless communication device is vertically projected onto the ground, and the center intersection line may be an intersection line between the ground and the antenna array of the wireless communication device when the center of the antenna array of the wireless communication device is vertically projected onto the ground.

The plurality of communication distances may be distances between the center of the antenna array of the plurality of communication target devices and the center of the antenna array of the wireless communication device, respectively.

The processor may be configured to first-sort the plurality of communication target devices based on the plurality of azimuth angles, and second-sort the first-sorted plurality of communication target devices based on the plurality of communication distances.

The processor may be configured to first-sort the plurality of communication target devices in ascending or descending order of the plurality of azimuth angles.

The processor may be configured to select communication target devices, on which second sorting is to be performed, from among the first-sorted plurality of communication target devices, based on a beam width of the wireless communication device, and second-sort the communication target devices selected as a target for the second sorting in ascending or descending order of the plurality of communication distances.

The processor may be configured to determine the plurality of beamforming matrixes so that interferences between the sorted plurality of communication target devices and an adjacent communication target device may be reduced or removed.

The processor may be configured to subtract, from phase change discrete Fourier transform (DFT) matrixes of the plurality of communication target devices, a multiplication of a phase change DFT matrix of an adjacent communication target device and a conjugate transposed matrix of the phase change DFT matrix of the adjacent communication target device to determine the plurality of beamforming matrixes, respectively.

The processor may be configured to multiply a plurality of transmission-targeted signals, which are to be transmitted to the plurality of communication target devices, by the plurality of beamforming matrixes to generate the wireless signal.

In one or more embodiments, there is provided a method of performing interference removal beamforming in a wireless communication system including a base station and a plurality of user terminals. The method may include: identifying spatial relationships between the base station and the plurality of user terminals using azimuth parameters and distance parameters between the base station and the plurality of user terminals; sorting the plurality of user terminals based on the azimuth parameters to form an azimuth-ordered list; selecting, from the azimuth-ordered list, a subset of user terminals located within a predefined beam width of the base station; sorting the selected subset of user terminals based on the distance parameters to form a distance-ordered list; determining a plurality of beamforming matrixes based on the distance-ordered list of the plurality of user terminals, and generating a wireless signal which is to be transmitted to the plurality of user terminals, based on the plurality of beamforming matrixes.

The determining of the plurality of beamforming matrixes may include determining the plurality of beamforming matrixes so that interferences between the sorted plurality of user terminals and an adjacent user terminal may be reduced or removed.

Hereinabove, exemplary embodiments have been described in the drawings and the specification. Embodiments have been described by using the terms described herein, but this has been merely used for describing the inventive concept and has not been used for limiting a meaning or limiting the scope of the inventive concept defined in the following claims. Therefore, it may be understood by those of ordinary skill in the art that various modifications and other equivalent embodiments may be implemented from the inventive concept. Accordingly, the spirit and scope of the inventive concept may be defined based on the spirit and scope of the following claims.

While the inventive concept has been particularly shown and described with reference to embodiments thereof, it will be understood that various changes in form and details may be made therein without departing from the spirit and scope of the following claims.

What is claimed is:

1. An operating method of a wireless communication device performing communication with a plurality of communication target devices, the operating method comprising:
calculating a plurality of azimuth angles between the plurality of communication target devices and the wireless communication device, respectively;
calculating a plurality of communication distances between the plurality of communication target devices and the wireless communication device, respectively;
sorting the plurality of communication target devices, based on the plurality of azimuth angles and the plurality of communication distances, respectively;
determining a plurality of beamforming matrixes on the sorted plurality of communication target devices, respectively; and
generating a wireless signal which is to be transmitted to the plurality of communication target devices, based on the plurality of beamforming matrixes, respectively.

2. The operating method of claim 1, wherein the plurality of azimuth angles are angles between a center intersection line and a plurality of connection lines, respectively,
the plurality of connection lines connect centers of antenna arrays of the plurality of communication target devices to a center intersection point of the antenna array of the wireless communication device, respectively,
the center intersection point is an intersection point between a ground and a center of the antenna array of the wireless communication device when the center of the antenna array of the wireless communication device is vertically projected onto the ground, and
the center intersection line is an intersection line between the ground and the antenna array of the wireless communication device when the center of the antenna array of the wireless communication device is vertically projected onto the ground.

3. The operating method of claim 1, wherein the plurality of communication distances are distances between centers of antenna arrays of the plurality of communication target devices and a center of an antenna array of the wireless communication device, respectively.

4. The operating method of claim 1, wherein the sorting comprises:
performing first sorting on the plurality of communication target devices based on the plurality of azimuth angles to obtain first-sorted plurality of communication target devices; and
performing second sorting on the first-sorted plurality of communication target devices based on the plurality of communication distances.

5. The operating method of claim 4, wherein the first sorting comprises performing the first sorting on the plurality of communication target devices in ascending or descending order of the plurality of azimuth angles.

6. The operating method of claim 4, wherein the second sorting comprises:
selecting a set of communication target devices, based on a beam width of the wireless communication device; and
performing the second sorting on the selected set of communication target devices in ascending or descending order of the plurality of communication distances, based on the plurality of communication distances.

7. The operating method of claim 1, wherein the determining the plurality of beamforming matrixes on the sorted plurality of communication target devices comprises determining the plurality of beamforming matrixes so that interferences between the sorted plurality of communication target devices and an adjacent communication target device are reduced or removed.

8. The operating method of claim 7, wherein the determining the plurality of beamforming matrixes comprises subtracting, from phase change discrete Fourier transform (DFT) matrixes of the plurality of communication target devices, a multiplication of a phase change DFT matrix of the adjacent communication target device and a conjugate transposed matrix of the phase change DFT matrix of the adjacent communication target device to determine the plurality of beamforming matrixes, respectively.

9. The operating method of claim 1, wherein the generating the wireless signal which is to be transmitted to the plurality of communication target devices comprises multiplying a plurality of transmission-targeted signals, which are to be transmitted to the plurality of communication target devices, by the plurality of beamforming matrixes to generate the wireless signal.

10. A wireless communication device performing communication with a plurality of communication target devices, the wireless communication device comprising:
a processor configured to generate a wireless signal; and
a transceiver configured to transmit the wireless signal,
wherein the processor is configured to
calculate a plurality of azimuth angles between the plurality of communication target devices and the wireless communication device, respectively,
calculate a plurality of communication distances between the plurality of communication target devices and the wireless communication device, respectively,
sort the plurality of communication target devices, based on the plurality of azimuth angles and the plurality of communication distances, respectively
determine a plurality of beamforming matrixes on the sorted plurality of communication target devices, respectively, and
generate the wireless signal which is to be transmitted to the plurality of communication target devices, based on the plurality of beamforming matrixes.

11. The wireless communication device of claim 10, wherein the plurality of azimuth angles are angles between a center intersection line and a plurality of connection lines, respectively,
the plurality of connection lines connect centers of antenna arrays of the plurality of communication target devices to a center intersection point of the antenna array of the wireless communication device, respectively,
the center intersection point is an intersection point between a ground and a center of the antenna array of the wireless communication device when the center of the antenna array of the wireless communication device is vertically projected onto the ground, and
the center intersection line is an intersection line between the ground and the antenna array of the wireless communication device when the center of the antenna array of the wireless communication device is vertically projected onto the ground.

12. The wireless communication device of claim 10, wherein the plurality of communication distances are distances between the center of the antenna array of the plurality of communication target devices and the center of the antenna array of the wireless communication device, respectively.

13. The wireless communication device of claim 10, wherein the processor is configured to
first-sort the plurality of communication target devices based on the plurality of azimuth angles, and
second-sort the first-sorted plurality of communication target devices based on the plurality of communication distances.

14. The wireless communication device of claim 13, wherein the processor is configured to first-sort the plurality of communication target devices in ascending or descending order of the plurality of azimuth angles.

15. The wireless communication device of claim 13, wherein the processor is configured to select communication target devices, on which second sorting is to be performed, from among the first-sorted plurality of communication target devices, based on a beam width of the wireless communication device, and second-sort the communication target devices selected as a target for the second sorting in ascending or descending order of the plurality of communication distances.

16. The wireless communication device of claim 10, wherein the processor is configured to determine the plurality of beamforming matrixes so that interferences between the sorted plurality of communication target devices and an adjacent communication target device is reduced or removed.

17. The wireless communication device of claim 10, wherein the processor is configured to subtract, from phase change discrete Fourier transform (DFT) matrixes of the plurality of communication target devices, a multiplication of a phase change DFT matrix of an adjacent communication target device and a conjugate transposed matrix of the phase change DFT matrix of the adjacent communication target device to determine the plurality of beamforming matrixes, respectively.

18. The wireless communication device of claim 10, wherein the processor is configured to multiply a plurality of transmission-targeted signals, which are to be transmitted to the plurality of communication target devices, by the plurality of beamforming matrixes to generate the wireless signal.

19. A method of performing interference removal beamforming in a wireless communication system comprising a base station and a plurality of user terminals, the method comprising:
identifying spatial relationships between the base station and the plurality of user terminals using azimuth parameters and distance parameters between the base station and the plurality of user terminals;
sorting the plurality of user terminals based on the azimuth parameters to form an azimuth-ordered list;
selecting, from the azimuth-ordered list, a subset of user terminals located within a predefined beam width of the base station;
sorting the selected subset of user terminals based on the distance parameters to form a distance-ordered list;
determining a plurality of beamforming matrixes based on the distance-ordered list of the plurality of user terminals, and
generating a wireless signal which is to be transmitted to the plurality of user terminals, based on the plurality of beamforming matrixes.

20. The method of claim 19, wherein the determining of the plurality of beamforming matrixes comprises determining the plurality of beamforming matrixes so that interferences between the sorted plurality of user terminals and an adjacent user terminal is reduced or removed.
